(19) United States
(12) Patent Application Publication
(10) Pub. No.: US 2020/0265464 A1
(43) Pub. Date: Aug. 20, 2020

(54) METHOD, SYSTEM AND NON-TRANSITORY COMPUTER-READABLE RECORDING MEDIUM FOR ESTIMATING EMOTION FOR ADVERTISING CONTENTS BASED ON VIDEO CHAT

(71) Applicant: SMOOTHY INC., Seoul (KR)

(72) Inventors: Hyun Geun JO, Yongin-si, Gyeonggi-do (KR); Deok Won KIM, Bucheon-si, Gyeonggi-do (KR)

(73) Assignee: SMOOTHY INC., Seoul (KR)

(21) Appl. No.: 16/081,715

(22) PCT Filed: Aug. 24, 2018
(86) PCT No.: PCT/KR2018/009837

§ 371 Date: Sep. 6, 2018

(30) Foreign Application Priority Data
Nov. 9, 2017 (KR) 10-2017-0148816

(51) Int. Cl. G06Q 30/02; G06K 9/00; H04N 7/14

(52) U.S. Cl. CPC G06Q 30/0245; H04N 7/141; G06K 9/00302

(57) ABSTRACT

According to an aspect of the present invention, there is provided a method for estimating an emotion about an advertising content on the basis of a video chat, the method including providing an advertising content to at least one talker participating in the video chat, estimating an emotion of the at least one talker about the advertising content on the basis of at least one of a facial expression and chat contents of the at least one talker, and verifying whether the estimated emotion relates to the advertising content on the basis of gaze information of the at least one talker.

### CROSS-REFERENCE TO RELATED APPLICATION

This application is a national phase of International Application No. PCT/KR2018/009837 filed on Aug. 24, 2018, which claims priority to and the benefit of Korean Patent Application No. 2017-148816, filed on Nov. 9, 2017, the disclosure of which is incorporated herein by reference in its entirety.

### BACKGROUND

### 1. Field of the Invention

The present invention relates to a method, a system, and a non-transitory computer-readable medium for estimating emotion for advertising contents based on a video chat.

### 2. Discussion of Related Art

As the Internet and video technologies evolve, people are increasing using a vivid video chat away from a conventional voice call or a conventional text chat. Further, the market for advertising using such a video chat is continuously growing. In addition, various studies are being conducted on how to efficiently provide advertisements to chat participants based on a video chat.

In this regard, an example of the related art includes a method which is performed by a chat service providing server configured to provide a chat service to a user terminal via a network, and in which when a chat service request is received from the user terminal, a chat room of one or more chat rooms is provided to the user terminal, and advertising contents are configured and transmitted independent from the chat room and then are displayed on the user terminal by being overlapped with the chat room so as to allow the advertising contents be exposed to the chat room.

Another example of the related art includes an apparatus for recognizing an emotion state of a chat participant, the apparatus including an excitement measurement unit configured to calculate values corresponding to degrees of excitement of one or more participants on the basis of times when the one or more participants input chats in a chat room, an emotion measurement unit configured to recognize facial expressions corresponding to the one or more participants and calculate values corresponding to emotions on the basis of the facial expressions, and an emotion state recognition unit configured to group the chats according to subjects as the same subject chat group and recognize emotion states of the one or more participants on the basis of time information corresponding to the same subject chat group, the values corresponding to the emotions, and the values corresponding to the degrees of excitement.

However, according to the above-described conventional techniques and the existing techniques, an advertisement can be exposed to only talkers participating in a chat room or only current emotion states of the talkers can be recognized through chat contents, and thus there is no way to measure an effect of a corresponding advertisement to the talkers by recognizing emotions which are felt by the talker about the advertisement. Further, it is even harder to know whether the emotions of the talker about the corresponding advertisement are really generated by the corresponding advertisement.

Accordingly, the present inventors propose a technique capable of accurately analyzing an effect of an advertisement to a talker by naturally obtaining information on a facial expression and a chat content of the talker on the basis of a video chat, estimating an emotion felt by the talker on the basis of the obtained information, and verifying whether the estimated emotion is generated by the advertisement on the basis of gaze information of the talker.

### SUMMARY OF THE INVENTION

An objective of the present invention is to resolve all the above-described problems of the related art.

Further, another objective of the present invention is to estimate an emotion of a talker about an advertising content on the basis of a facial expression and a chat content of the talker, verify the estimated emotion on the basis of gaze information of the talker, and accurately determine whether the estimated emotion is related to the advertising content.

Furthermore, still another objective of the present invention is to maximize advertisement efficiency by providing an appropriate advertising content on the basis of an emotion of the talker.

Additionally, yet another objective of the present invention is to resolve repulsion or a privacy problem for image acquisition by naturally acquiring a facial expression or gaze information of a talker during in a video chat.

A typical configuration of the present invention for achieving the above-described objectives is as follows.

According to an aspect of the present invention, there is provided a method for estimating an emotion about an advertising content on the basis of a video chat, the method including providing an advertising content to at least one talker participating in the video chat, estimating an emotion of the at least one talker about the advertising content on the basis of at least one of a facial expression and chat contents of the at least one talker, and verifying whether the estimated emotion relates to the advertising content on the basis of gaze information of the at least one talker.

According to another aspect of the present invention, there is provided a system for estimating an emotion about an advertising content on the basis of a video chat, the system including an advertising content management unit configured to provide an advertising content to at least one talker participating in a video chat, an emotion estimation unit configured to estimate an emotion of the at least one talker about the advertising content on the basis of at least one of a face expression and chat contents of the at least one talker receiving the advertising content, and an emotion verification unit configured to whether the estimated emotion relates to the advertising content on the basis of gaze information of the at least one talker.

In addition to the foregoing, there are provided another method for implementing the present invention, another system, and a non-transitory computer-readable recording medium for recording a computer program for performing another method.

### BRIEF DESCRIPTION OF THE DRAWINGS

FIG. 1 is a diagram illustrating a schematic configuration of an overall system for estimating an emotion about an advertising content on the basis of a video chat according to one embodiment of the present invention.

FIG. 2 is a detailed diagram illustrating an internal configuration of an emotion estimation system according to one embodiment of the present invention.

FIG. 3 is a diagram exemplifying a situation in which an emotion of a chat participant about an advertising content is estimated on the basis of a video chat according to one embodiment of the present invention.

FIG. 4 depicts diagrams exemplifying user interfaces provided to a talker device according to one embodiment of the present invention.

FIG. 5 depicts a diagram exemplifying a user interface provided to a talker device according to one embodiment of the present invention.

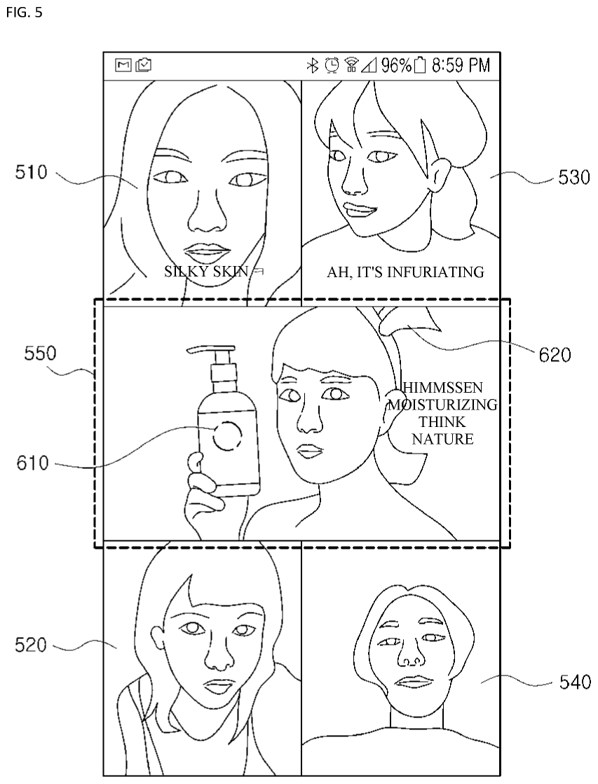

### DETAILED DESCRIPTION OF EXEMPLARY EMBODIMENTS

In the following detailed description, reference is made to the accompanying drawings that illustrates, by way of illustration, specific embodiments in which the present invention may be practiced. These embodiments are described in sufficient detail to enable those skilled in the art to practice the present invention. It should be understood that various embodiments of the present invention, although different, are not necessarily mutually exclusive. For example, specific forms, structures, and characteristics described herein may be implemented by being altered from one embodiment to another embodiment without departing from the spirit and scope of the present invention. Further, it should be understood that positions or arrangement of individual elements within each embodiment may also be modified without departing from the spirit and scope of the present invention. Accordingly, the following detailed description is not to be taken in a limiting sense, and the scope of the present invention should be construed to include the scope of the appended claims and equivalents thereof. In the drawings, like numerals refer to the same or similar components throughout various aspects.

Hereinafter, exemplary embodiments of the present invention will be described in detail with reference to the accompanying drawings so as to enable those skilled in the art to which the present invention pertains to practice the present invention.

In this disclosure, a content is a concept that collectively refers to digital information or individual information elements configured with characters, symbols, voices, sounds, images, moving images, and the like. For example, such a content may be configured to include pieces of data, such as texts, images, moving pictures, audios, and links (e.g., web links), or a combination of at least two of the pieces of data.

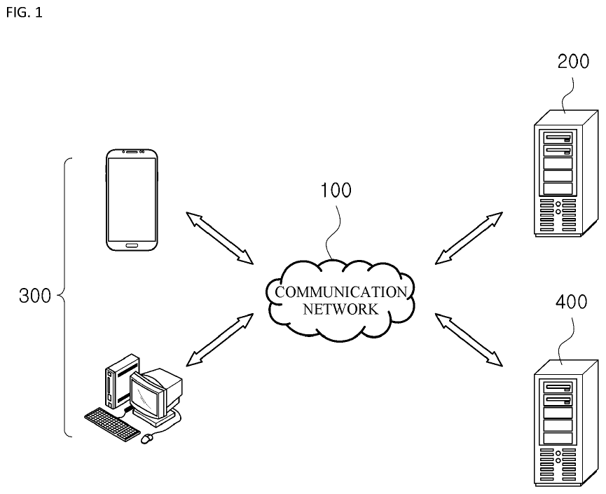

Configuration of Overall System FIG. 1 is a diagram illustrating a schematic configuration of an overall system for estimating an emotion about an advertising content on the basis of a video chat according to one embodiment of the present invention.

As shown in FIG. 1, the overall system according to one embodiment of the present invention may include a communication network 100, an emotion estimation system 200, a talker device 300, and a video chat service providing system 400. First, the communication network 100 according to one embodiment of the present invention may be configured without regard to a communication aspect such as wired communication or wireless communication and may be configured with various communication networks such as a local area network (LAN), a metropolitan area network (MAN), a wide area network (WAN), and the like. Preferably, the communication network 100 referred to herein may be the known Internet or World Wide Web (WWW). However, the communication network 100 is not limited thereto and may include, at least in part, a known wired or wireless data communication network, a known telephone network, or a known wired or wireless television network.

For example, the communication network 100 may be a wireless data communication network which is, at least in part, implementation of a conventional communication method such as a wireless fidelity (Wi-Fi) communication method, a WiFi-Direct communication method, a long term evolution (LTE) communication method, a Bluetooth communication method (e.g., a Bluetooth low energy (BLE) communication method), an infrared communication method, an ultrasonic communication method, and the like.

Next, the emotion estimation system 200 according to one embodiment of the present invention may communicate with the talker device 300 and the video chat service providing system 400, which will be described below, through the communication network 100, and the emotion estimation system 200 may perform a function of providing an advertising content to at least one talker participating in a video chat, estimating an emotion of the at least one talker about the provided advertising content on the basis of at least one of a facial expression and a chat content of the at least one talker, and verifying whether the estimated emotion is related to the provided advertising content on the basis of gaze information of the at least one talker.

A configuration and a function of the emotion estimation system 200 according to the present invention will be provided in detail through the following detailed description. While the emotion estimation system 200 has been described as above, this description is illustrative, and it will be obvious to those skilled in the art that at least some of functions or components required for the emotion estimation system 200 may be implemented, if necessary, in the talker device 300, the video chat service providing system 400, or an external system (not shown) or may be included, if necessary, in the talker device 300, the video chat service providing system 400, or the external system.

Next, according to one embodiment of the present invention, the talker device 300 is a digital device including a function capable of accessing and communicating with the emotion estimation system 200 and the video chat service providing system 400 through the communication network 100, and any digital device may be adopted as the talker device 300 as long as it includes a memory part, such as a smart phone, a notebook, a desktop, a tablet personal computer (PC), and the like, and has a computing ability by embedding a microprocessor. Further, according to one embodiment of the present invention, the talker device 300 may further include a camera module (not shown) for using the above-described video chat service or acquiring a facial expression and gaze information of the talker.

Meanwhile, according to one embodiment of the present invention, the talker device 300 may include an application for supporting a function according to the present invention for estimating an emotion of a chat participant about an advertising content on the basis of a video chat. Such an application may be downloaded from the emotion estimation system 200 or an external application distribution server (not shown).

Next, the video chat service providing system 400 according to one embodiment of the present invention may be a system for providing a chat service, which is capable of communicating with the emotion estimation system 200 and the talker device 300 through the communication network 100 and allowing transmission and reception of a chat on the basis of at least one of a video, a voice, and a text of at least one talker (i.e., the talker device 300). For example, the above-described video chat service may a service including at least a part of features or attributes of various known video chat services such as Duo (Google), Airlive (Air Live Korea), Houseparty (Life on Air), and the like.

Configuration of Emotion Estimation System Hereinafter, an internal configuration and each component of the emotion estimation system 200 performing an important function for implementing the present invention will be described.

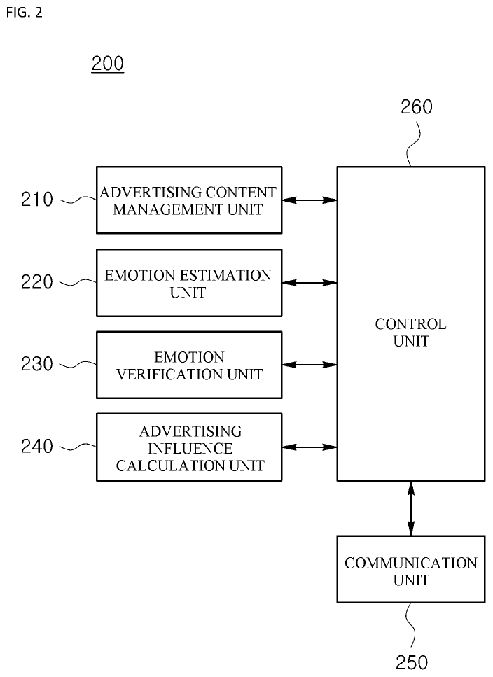

FIG. 2 is a detailed diagram illustrating an internal configuration of the emotion estimation system 200 according to one embodiment of the present invention.

The emotion estimation system 200 according to one embodiment of the present invention may be a digital device including a memory unit and having a computing ability by embedding a microprocessor. The emotion estimation system 200 may be a server system. As shown in FIG. 2, the emotion estimation system 200 may be configured to include an advertising content management unit 210, an emotion estimation unit 220, an emotion verification unit 230, an advertising influence calculation unit 240, a communication unit 250, and a control unit 260. According to one embodiment of the present invention, at least some of the advertising content management unit 210, the emotion estimation unit 220, the emotion verification unit 230, the advertising influence calculation unit 240, the communication unit 250, and the control unit 260 of the emotion estimation system 200 may be a program module communicating with an external system. Such a program module may be included in the emotion estimation system 200 in the form of an operating system, an application program module, or other program module and may be physically stored in various known storage devices. Further, the program module may be stored in a remote storage device capable of communicating with the emotion estimation system 200. Alternatively, the program module collectively includes, according to the present invention, a routine, a subroutine, program, an object, a component, a data structure, and the like which perform a specific task or a specific abstract data type, which will be described below, but the present invention not limited thereto.

First, the advertising content management unit 210 according to one embodiment of the present invention may perform a function of providing an advertising content to at least one talker participating in a video chat. According to one embodiment of the present invention, the at least one talker receiving the advertising content may mean a talker who is present (or participates) in the same group (e.g., the same chat room) among chat groups configured by at least one talker in the video chat.

For example, the advertising content management unit 210 according to one embodiment of the present invention may determine an advertising content, which will be provided to a corresponding talker participating in the video chat, on the basis of a facial expression of the corresponding talker and chat contents transmitted and received by the corresponding talker.

More specifically, the advertising content management unit 210 according to one embodiment of the present invention may estimate an emotion state of the corresponding talker by analyzing the facial expression of the corresponding talker participating in the video chat and the chat contents transmitted and received by the corresponding talker and may provide the corresponding talker with an advertising content relating to the estimated emotion state. For example, the advertising content management unit 210 according to one embodiment of the present invention may specify an emotion state corresponding to a facial expression of a corresponding talker on the basis of a pattern in which main feature elements of a face of the corresponding talker are varied, and an emotion state corresponding to chat contents of the corresponding talker by analyzing words, sentences, paragraphs, and the like, which are related to an emotion, included in the chat contents transmitted and received by the corresponding talker. Further, the advertising content management unit 210 according to one embodiment of the present invention may estimate an emotion state of a talker on the basis of at least one of emotion states specified from a facial expression and chat contents of the talker. In this case, the advertising content management unit 210 according to one embodiment of the present invention may estimate the emotion state of the talker on the basis of predetermined weighting factors respectively assigned to the emotion state specified from the facial expression of the talker and the emotion state specified from the chat contents of the talker. Further, according to one embodiment of the present invention, in order to estimate the emotion state of the talker, the advertising content management unit 210 may complementarily refer to the estimated emotion state specified from the facial expression of the talker and the estimated emotion state specified from the chat contents of the talker. Furthermore, in order to determine an advertising content relating to the estimated emotion states, the advertising content management unit 210 according to one embodiment of the present invention may refer to a look-up table in which at least one emotion state and at least one advertising content are matched.

Alternatively, the advertising content management unit 210 according to one embodiment of the present invention may refer to at least one among personal information of a talker, a social network service (SNS) relating to the talker, and information (e.g., call history, messages, schedules, and Internet cookie information) stored in a talker device in order to provide an advertising content to at least one talker participating in a video chat.

Further, the advertising content management unit 210 according to one embodiment of the present invention may provide advertising contents to two or more talkers at the same point of time, and in this case, all the advertisement contents provided to the one or more talkers are the same content.

For example, the advertising content management unit 210 according to one embodiment of the present invention may provide the same advertising contents to two or more talkers participating in a video chat at the same point of time, and thus the provided advertising contents become a common chat theme between the two or more talkers participating in the video chat, so that the two or more talkers may naturally share thoughts (i.e., chats containing emotions) about the provided advertising contents.

Next, the emotion estimation unit 220 according to one embodiment of the present invention may perform a function of estimating an emotion of at least one talker about an advertising content on the basis of at least one of a facial expression and chat contents of the at least one talker. According to one embodiment of the present invention, an emotion of a talker about an advertising content may be variously classified according to predetermined criteria such as an affirmative or negative dichotomy, and affirmative, negative, neutral, or objective quartering.

Specifically, the emotion estimation unit 220 according to one embodiment of the present invention may estimate an emotion of at least one talker about an advertising content while the advertising content is provided to the at least one talker, or within a predetermined time after the advertising content is provided to the at least one talker on the basis of at least one of an emotion specified from a facial expression of the at least one talker and an emotion specified from chat contents of the at least one talker.

Meanwhile, in order to specify an emotion of a talker from a facial expression and chat contents of the talker, the emotion estimation unit 220 according to one embodiment of the present invention may use various known emotion analysis algorithms such as an emotion pattern recognition algorithm and a natural language analysis algorithm. Further, in order to specify the emotion of the talker more accurately, the emotion estimation unit 220 according to one embodiment of the present invention may use a known machine learning algorithm or a known deep learning algorithm.

Furthermore, while estimating an emotion of at least one talker about an advertising content, the emotion estimation unit 220 according to one embodiment of the present invention may estimate the emotion of the at least one talker on the basis of a playback section or a playback frame of the advertising content.

For example, according to one embodiment of the present invention, a talker may have different emotion states for each playback section or each playback frame while the advertising content is played back, and thus the emotion estimation unit 220 may estimate the emotion of the talker for each playback section (e.g., every 5 seconds) or each playback frame.

Next, the emotion verification unit 230 according to one embodiment of the present invention may verify whether the emotion estimated by the emotion estimation unit 220 relates to the advertising content on the basis of gaze information of the talker.

Specifically, the emotion verification unit 230 according to one embodiment of the present invention may verify whether the estimated emotion relates to the advertising content on the basis of at least one among a time for which the talker gazes the advertising content, an area gazed by the talker within a displayed area of the advertising content, and a section gazed by the talker within a playback section of the advertising content.

For example, when the time for which the talker gazes the advertising content is greater than or equal to a predetermined time (e.g., 5 seconds or more), or a ratio of the time for which the talker gazes the advertising content to a playback time of the advertising content is greater than or equal to a predetermined ratio (e.g., 10% or more), the emotion verification unit 230 according to one embodiment of the present invention may determine the estimated emotion of the talker as relating to the advertising content.

Alternatively, the emotion verification unit 230 according to one embodiment of the present invention may determine whether the estimated emotion of the talker relates to the advertising content by specifying an area gazed by the talker among areas in which the advertising content is displayed on a screen of the talker device 300 at a point of time when the emotion of the talker is estimated (or before or after the point of time) and comparing and analyzing the estimated emotion of the talker with a target object included in the specified area.

Further alternatively, the emotion verification unit 230 according to one embodiment of the present invention may determine whether the estimated emotion of the talker relates to the advertising content by specifying a section in which the emotion of the talker is estimated during the playback section of the advertising content and comparing and analyzing the estimated emotion of the talker with a target object (or a behavior) included in the specified section.

Next, the advertising influence calculation unit 240 according to one embodiment of the present invention may calculate advertising influence information of an advertising content affecting to at least one talker on the basis of the verification result of the emotion verification unit 230.

For example, the advertising influence information according to one embodiment of the present invention may be calculated on the basis of information regarding at least one of concentration on the advertising content and an emotion generation element for each playback section (or a screen area) of the advertising content.

According to one embodiment of the present invention, the concentration on the advertising content may be a concept including at least one of a time for which the talker gazes the advertising content, an average gaze time of talkers about the advertising content, and a point of time when the talker stops gazing or starts to gaze the advertising content within the playback section of the advertising content. Further, according to one embodiment of the present invention, the emotion generation element for each playback section of the advertising content (or for each screen section) may be a concept including information regarding whether the estimated emotion of the talker in the advertising content matches which playback section of the advertising content or which area of the advertising content.

Next, the communication unit 250 according to one embodiment of the present invention performs a function of allowing data transmission and reception from and to the advertising content management unit 210, the emotion estimation unit 220, the emotion verification unit 230, and the advertising influence calculation unit 240.

Finally, the control unit 260 according to one embodiment of the present invention performs a function of controlling a flow of pieces of data between the advertising content management unit 210, the emotion estimation unit 220, the emotion verification unit 230, the advertising influence calculation unit 240, and the communication unit 250. That is, the control unit 260 according to the present invention may control each of the advertising content management unit 210, the emotion estimation unit 220, the emotion verification unit 230, the advertising influence calculation unit 240, and the communication unit 250 to perform a specific function by controlling the flow of the pieces of data from and to the outside of the emotion estimation system 200 or between the components of the emotion estimation system 200.

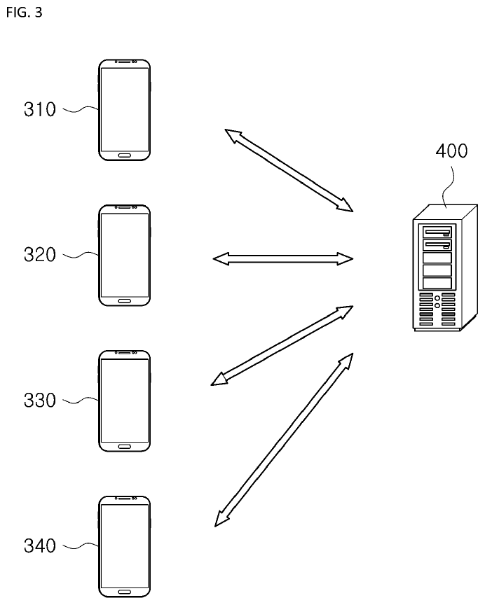

FIG. 3 is a diagram exemplifying a situation in which an emotion of a chat participant about an advertising content is estimated on the basis of a video chat according to one embodiment of the present invention.

Referring to FIG. 3, it can be assumed that the emotion estimation system 200 according to one embodiment of the present invention is included in the video chat service providing system 400 according to the present invention.

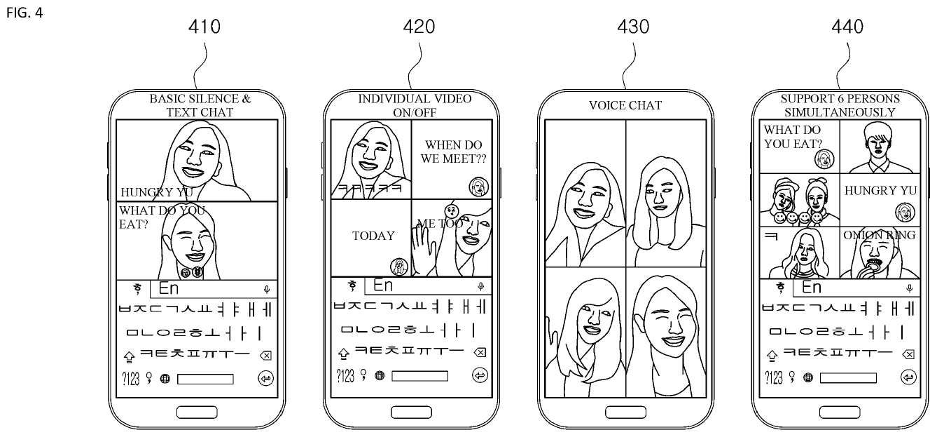

FIGS. 4 and to 5 are diagrams exemplifying user interfaces provided to the talker device 300 according to one embodiment of the present invention.

According to one embodiment of the present invention, a video chat service may be provided to talker devices 310, 320, 330, and 340 through the video chat service providing system 400, and the video chat service may be a service of allowing two or more talkers to transmit and receive chats among the two or more talkers using at least one of images, voices, and texts.

For example, in accordance with one embodiment of the present invention, the video chat service may be provided as only images and characters 410 without voices, or as only images and voices 430 according to a setting of the talker. Further, according to one embodiment of the present invention, the video chat service may turn on or off an image 420, which is provided to another talker, according to the setting of the talker.

Meanwhile, according to one embodiment of the present invention, a screen 440 provided on each of the talker devices 310, 320, 330, and 340 may be symmetrically or asymmetrically divided on the basis of the number of participants who participate in the video chat service.

First, the video chat service providing system 400 according to one embodiment of the present invention may determine that emotion states of four talkers 510, 520, 530, and 540 (a first talker 510, a second talker 520, a third talker 530, and a fourth talker 540) are all in a “joyful” state and talk about a theme of skin moisturization on the basis of facial expressions and chat contents of the four talkers 510, 520, 530, and 540 and may determine an advertising content 550 corresponding to the facial expressions and the chat contents.

Then, according to one embodiment of the present invention, the determined advertising content 550 may be provided to the four talkers 510, 520, 530, and 540 at the same point of time. Meanwhile, a position, a size, or an arrangement of the advertising content 550 on the screen of each of the talker devices 310, 320, 330, and 340 may be dynamically changed according to the number of chat participants and the like.

Next, according to one embodiment of the present invention, an emotion of each of the four talkers 510, 520, 530, and 540 about the advertising content 550 may be estimated on the basis of at least one of the facial expressions and the chat contents of the four talkers 510, 520, 530, and 540. According to one embodiment of the invention, these emotions (e.g., in this case, the emotion about the advertising content 550 may be discriminated into an affirmative and a negative) may be estimated such that the first talker 510 is “affirmative,” the second talker 520 is “negative,” the third talker 530 is “negative,” and the fourth talker 540 is “affirmative.”

Then, according to one embodiment of the present invention, whether the estimated emotions relate to the advertising content 550 may be verified on the basis of gaze information of the four talkers 510, 520, 530, and 540.

Specifically, in accordance with one embodiment of the present invention, whether the estimated emotions (i.e., the first talker 510 is “affirmative,” the second talker 520 is “negative,” the third talker 530 is “negative,” and the fourth talker 540 is “affirmative”) relate to the advertising content 550 may be verified on the basis of at least one among a time for which each of the talkers 510, 520, 530, and 540 gazes the advertising content 550, an area gazed by each of the talkers 510, 520, 530, and 540 within displayed areas of the advertising content 550, and a section gazed by each of the talkers 510, 520, 530, and 540 in a playback section of the advertising content 550.

That is, according to one embodiment of the present invention, when a time for which the first talker 510 gazes the advertising content 550 is greater than or equal to a predetermined time, the emotion (i.e., “affirmative”) of the first talker 510 may be verified as relating to the advertising content 550, and the emotion of the first talker 510 about the advertising content 550 may be verified as being “affirmative,” and when the area gazed by the second talker 520 is an advertising target product 610 among the displayed areas of the advertising content 550 at a point of time (or before or after the point of time) when the emotion (i.e., “negative”) of the second talker 520 is estimated, the emotion (i.e., “negative”) of the second talker 520 may be verified as relating to the advertising content 550, and the emotion of the second talker 520 about the advertising content 550 may be verified as being “negative,” and when a section in which the emotion (i.e., “negative”) of the third talker 530 is estimated is a section in which an advertisement model uses the advertising target product 610 during the playback section of the advertising content 550, the emotion (i.e., “negative”) of the third talker 530 may be verified as relating to the advertising content 550, and the emotion of the third talker 530 about the advertising content 550 may be verified as being “affirmative,” and when the area gazed by the fourth talker 540 is a ribbon 620 rather than the advertising target product 610 or is the outside (not shown) of the displayed areas of the advertising content 550 at a point of time when the emotion (i.e., “affirmative”) of the fourth talker 540 is estimated, the emotion (i.e., “affirmative”) of the fourth talker 540 may be verified as not relating to the advertising content 550.

Then, the video chat service providing system 400 according to one embodiment of the present invention may calculate advertising influence information regarding which the advertising content 550 affects at least one talker on the basis of the verification results.

According to the present invention, the emotion of the talker about the advertising content is estimated on the basis of the facial expression and the chat contents of the talker, and the emotion of the talker is verified using the gaze information, so that whether the estimated emotion relates to the advertising content can be accurately estimated.

Further, according to the present invention, an appropriate advertising content is provided on the basis of the emotion of the talker, so that advertisement efficiency can be maximized.

Furthermore, according to the present invention, the facial expression or the gaze information of the talker is naturally acquired during the video chat, so that repulsion or a privacy problem for image acquisition can be resolved.

The above-described embodiments according to the present invention may be implemented in the form of a program command which is executable through various computer components and may be recorded in a computer-readable recording medium. The computer-readable recording medium may include program commands, data files, data structures, and the like in alone or a combination thereof. The program commands recorded in the computer-readable recording medium may be specially designed and configured for the present invention or may be available to those skilled in the computer software. Examples of the computer-readable recording media include magnetic media such as a hard disk, a floppy disk, and a magnetic tape, optical recording media such as a compact disc read only memory (CD-ROM) and a digital versatile disc (DVD), a magneto-optical medium such as a floptical disk, medium, and hardware devices specifically configured to store and execute program commands, such as a read only memory (ROM), a random access memory (RAM), a flash memory, and the like. Examples of the program commands include machine language codes generated by a compiler, as well as high-level language codes which are executable by a computer using an interpreter or the like. The hardware devices may be modified as one or more software modules so as to perform an operation of the present invention, and vice versa.

While the present invention has been described with reference to specific items such as particular components, exemplary embodiments, and drawings, these are merely provided to help understanding the present invention, and the present invention is not limited to these embodiments, and those skilled in the art to which the present invention pertains can variously alter and modify from the description of the present invention.

Therefore, the spirit of the present invention should not be limited to the above-described embodiments, and it should be construed that the appended claims as well as all equivalents or equivalent modifications of the appended claims will fall within the scope of the present invention.

What is claimed is:

1. A method for estimating an emotion about an advertising content on the basis of a video chat, the method comprising:
providing an advertising content to at least one talker participating in the video chat;
estimating an emotion of the at least one talker about the advertising content on the basis of at least one of a facial expression and chat contents of the at least one talker; and
verifying whether the estimated emotion relates to the advertising content on the basis of gaze information of the at least one talker.

2. The method of claim 1, wherein, in the providing of the advertising content, advertising contents are provided to two or more talkers at the same point of time, and all the advertisement contents provided to the two or more talkers are the same content.

3. The method of claim 1, wherein, in the providing of the advertising content, the advertising content is determined on the basis of at least one of the facial expression and the chat contents of the at least one talker.

4. The method of claim 1, wherein, in the verifying, whether the estimated emotion relates to the advertising content is verified on the basis of at least one of a time for which the at least one talker gazes the advertising content, an area gazed by the at least one talker in displayed areas of the advertising content, and a section gazed by the at least one talker in a playback section of the advertising content.

5. A non-transitory computer-readable recording medium for recording a computer program for performing the method according to claim 1.

6. A system for estimating an emotion about an advertising content on the basis of a video chat, the system comprising:
an advertising content management unit configured to provide an advertising content to at least one talker participating in a video chat;
an emotion estimation unit configured to estimate an emotion of the at least one talker about the advertising content on the basis of at least one of a face expression and chat contents of the at least one talker receiving the advertising content; and
an emotion verification unit configured to whether the estimated emotion relates to the advertising content on the basis of gaze information of the at least one talker.
